(19) United States
(12) Patent Application Publication
(10) Pub. No.: US 2018/0012280 A1
(43) Pub. Date: Jan. 11, 2018

(54) UNIVERSAL SHOPPING SEARCH ENGINE

(71) Applicant: MOBIFALCON, INC., DALLAS, TX (US)

(72) Inventor: EBENEZER ESHUN, FRISCO, TX (US)

(73) Assignee: MOBIFALCON, INC., DALLAS, TX (US)

(21) Appl. No.: 15/525,952

(22) PCT Filed: Nov. 6, 2015
(86) PCT No.: PCT/US15/59507

§ 371 Date: Aug. 23, 2017

Related U.S. Application Data
(60) Provisional application No. 62/077,507, filed on Nov. 10, 2014.

(51) Int. Cl. G06Q 30/06; G01C 21/20; G06F 17/30; G06Q 10/08

(52) U.S. Cl. CPC G06Q 30/0625; G06Q 10/087; G01C 21/20; G06F 17/30879

(57) ABSTRACT

In some embodiments, systems are provided to enable a consumer to search the inventory of an enable a consumer to search the inventory of a plurality of unaffiliated brick-and-mortar retail entities to facilitate purchase opportunities. The system may include electronic user devices comprising a search interface stored thereon. Databases can be communicatively coupled to a plurality of unaffiliated brick-and-mortar retail entities and configured to store inventory transaction data points received from unaffiliated brick-and-mortar retail entities. Each inventory transaction data point can correspond to descriptive characteristics of a first inventory item. Search requests for second inventory items can be received from search interfaces. Inventory transaction data points that correspond to first inventory items that each share a threshold number of descriptive characteristics with some second inventory items. One or more notifications can be generated when the threshold number of descriptive characteristics are confirmed, the notification can include descriptive characteristics.

### CROSS-REFERENCE TO RELATED APPLICATIONS

This application is a 371 filing of International Application No PCT/US15/59507 filed Nov. 6, 2015, which claims priority to U.S. Provisional Application No. 62/077,507 filed Nov. 10, 2014, which are each hereby incorporated herein by reference.

### BACKGROUND

The present invention relates generally to electronic commerce and specifically to universal shopping search engine. Electronic retail (“E-tail”) is related to the trading of physical goods through a website with storefront capabilities. E-tail may encompass business-to-consumer and/or business-to-business oriented commerce. Large scale brick-and-mortar retailers typically offer online search engine interfaces for consumers that are restricted to the particular retailer.

### BRIEF DESCRIPTION OF THE DRAWINGS

FIG. 1 depicts an environment, generally 100, in accordance with some embodiments.

FIG. 2A depicts an information transmission scheme, in accordance with some embodiments.

FIG. 2B depicts a serviced search request, generally 200, in accordance with some embodiments.

FIG. 2C depicts a symbolic depiction of a serviced search request, in accordance with some embodiments.

FIG. 3 illustrates the operational steps of a shopping search engine program, in accordance with some embodiments.

FIG. 4 depicts a block diagram of components of an electronic user device, in accordance with some embodiments.

### DETAILED DESCRIPTION

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. As used herein, the terms “merchant”, “retailer”, and “vendor” are used interchangeably. As used herein, the term “real-time” refers to data processing that occurs within milliseconds or at a rate that is difficult to capture by the human eye.

Electronic retail (“E-tail”) is typically related to the trading of goods and services through websites having storefront capabilities. E-tail may encompass business-to-consumer (“B2C”) and/or business-to-business (“B2B”) oriented commerce. Large scale brick-and-mortar retailers typically offer online search capabilities that allow consumers to search their inventory for desired goods. Such interfaces typically require costly programming and/or hosting capabilities. Embodiments of the present invention provide an E-tail solution that allows consumers to locate and subsequently purchase products (“inventory items”) and/or services of interest by searching the inventory of a plurality of merchants using a shopping search engine. In additional embodiments, in response to locating particular products, the E-tail solution comprises a shopping cart functionality allows consumers to accumulate one or more inventory items and to adjust their quantities, like filling a physical shopping cart or basket in a conventional store.

In other embodiments, the E-tail solution comprises a “checkout” process that collects payment and/or delivery information. In an embodiment, the E-tail solution allows a plurality of merchants to sync their inventory information with a single inventory information store to provide interested customers real-time or periodically refreshed inventory data, wherein the refreshing can occur at a pre-determined time period. In certain embodiments of the present invention, the E-tail solution allows users to locate merchants by address, and/or in-store inventory item locations (i.e. “aisle three”). As used herein, “brick-and-mortar retailer,” “brick-and-mortar merchant,” “retailer,” and “merchant” are used interchangeably and refer to retail entities having physical retail locations.

Generally speaking, pursuant to various embodiments, systems and methods are provided herein useful to enable a consumer to search the inventory′ of a plurality of unaffiliated brick-and-mortar retail entities to facilitate purchase opportunities. In some embodiments, systems are provided to enable a consumer to search the inventory of an enable a consumer to search the inventory of a plurality of unaffiliated brick-and-mortar retail entities to facilitate purchase opportunities. The system may include one or more electronic user devices each comprising a search interface stored thereon. One or more databases of information can be communicatively coupled to a plurality of unaffiliated brick-and-mortar retail entities and configured to store a plurality of inventory transaction data points received from the plurality of unaffiliated brick-and-mortar retail entities. By one approach, each inventory transaction data point can correspond to one or more descriptive characteristics of a first inventory item, where each descriptive characteristic can correspond to information comprising at least one of an itemID, an item type, sourcing information, a merchantID, a merchant location, a price, and an in-store item location.

One or more control circuits can be communicatively coupled to a transceiver and the databases. The control circuits can be configured to receive one or more inventory search requests for one or more second inventory items from the one or more search interfaces. The control circuits can also be configured to confirm that one or more inventory transaction data points of the plurality of inventory transaction data points comprises one or more first inventory item that each share a threshold number of descriptive characteristics with at least one of the second inventory items. The control circuits can also be configured to generate one or more notifications when the threshold number of descriptive characteristics are confirmed, the notification comprising information corresponding to one or more of the threshold number of descriptive characteristics.

In some embodiments, methods are provided to enable a consumer to search the inventory of a plurality of unaffiliated brick-and-mortar retail entities to facilitate purchase opportunities. Some of these methods can receive a plurality of inventory transaction data points from a plurality of unaffiliated brick-and-mortar retail entities, where each inventory transaction data point can comprise information corresponding to one or more descriptive characteristics of a first inventory item. By one approach, each descriptive characteristic can include information corresponding to one or more of an itemID, an item type, sourcing information, a merchantID, a merchant location, a price, and an in-store item location.

One or more inventory search requests can be received from one or more search interfaces, where each request can include information corresponding to one or more second inventory items. For example, each of the search interfaces can be stored on an electronic user device. One or more inventory transaction data points of a plurality of the inventory transaction data points can each be confirmed to include a first inventory item that shares a threshold number of descriptive characteristics with at least one of the second inventory items. One or more notifications can be generated when the presence of the threshold number of descriptive characteristics is confirmed. For example, the one or more notifications can include information corresponding to one or more of the threshold number of descriptive characteristics of the first inventory item.

Embodiments of the present invention seek to provide an E-tail solution comprising searchable inventory information to facilitate purchases. Additional aspects of the present invention seek to provide an E-tail solution that comprises the inventory of a plurality of merchants in the customer's immediate area (i.e. an area accessible by vehicle and/or walking). Other embodiments of the present invention seek to provide an E-tail solution that allows products to be filtered and compared based on price, features, merchant, and/or distance from consumer. Still other embodiments of the present invention seek to provide an E-tail solution that reflects the sales information of a plurality of merchants.

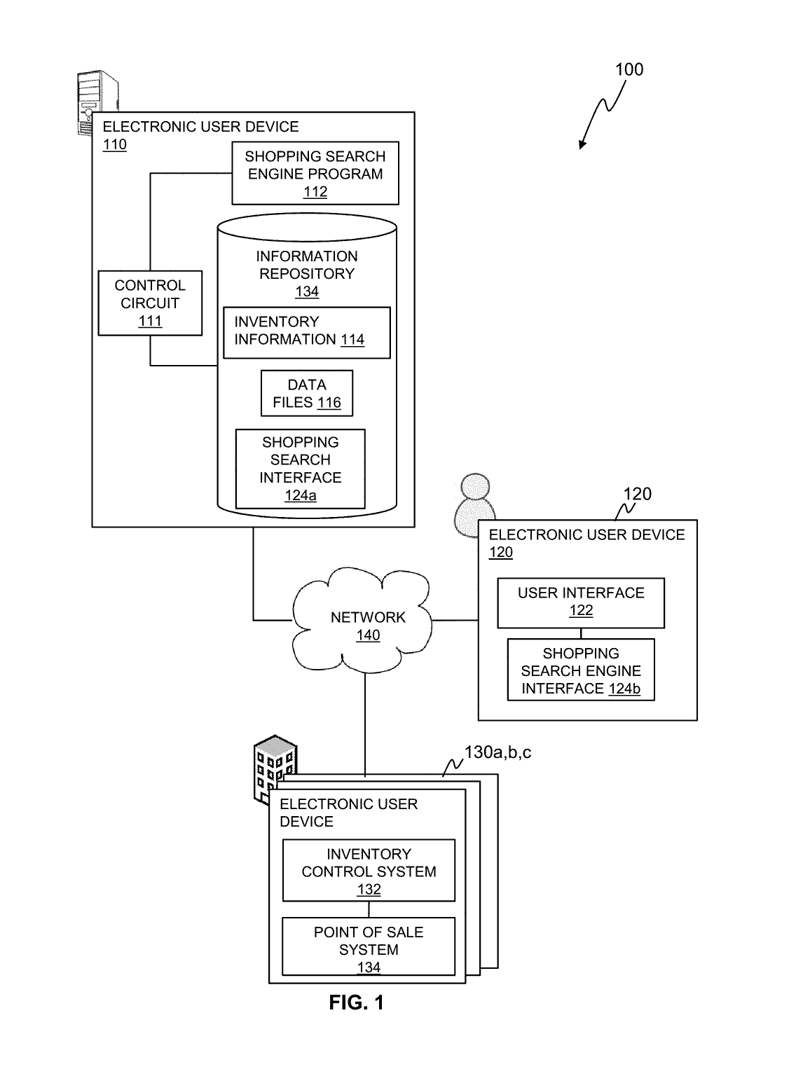

FIG. 1 depicts an environment, generally 100, in accordance with some embodiments. Environment 100 includes electronic user devices 110, 120, and 130 all in communication via network 140. Network 140 facilitates communication between electronic user devices 110, 120, and 130. Network 140 can be, for example, a local area network (LAN), a wide area network (WAN), such as the Internet, or a combination of the two, and can include wired, wireless, and/or fiber optic connections. Network 140 can be compatible with a variety of frequencies, such as those associated with Bluetooth, Wi-Fi, LTE, cellular, radio, microwave, as well as wireless communication.

In general, network 140 can be any combination of connections and protocols that will support communications between electronic user devices 110, 120 and 130. Electronic user devices of the present invention may be desktop computers, laptop computers, tablet computers, personal digital assistants (PDA), wearable computers, cluster computers, and/or smart phones. In general, electronic user devices of the present invention may be any electronic device or computing system capable of transmitting data, receiving data, and/or communicating with additional electronic user devices over network 140, in accordance with some embodiments.

Electronic user device 120 can be configured to allow users to engage in E-tail solutions, in accordance with some embodiments. Electronic user device 120 can include SSI 124b. SSI 124b may be graphics-, text-, audio-, and/or gesture-based. SSI 124b can be configured to be utilized by users to generate inventory search requests (“requests”) that correspond to inventory inquiries for one or more inventory items located at brick-and-mortar retail entities (e.g., a gallon of organic whole milk), in accordance with some embodiments.

For example, requests can include information that corresponds to descriptive characteristics of the sought after inventory items (e.g., itemID, price, preferred price range, product features, manufacturerID, merchantID, preferred distance from the user, similar descriptive information, or a combination of two or more thereof). SSI 124b can be configured to reduce the time required for users, such as those of electronic user device 120, to review inventory information of multiple websites for brick-and-mortar retail entities associated with electronic user devices 130 to ascertain inventory item availability and/or best price. SSI 124b can receive serviced requests from SSEP 112 (discussed below).

Electronic user devices 130a,b,c can each be configured to manage inventory transactions for a plurality of merchants, in accordance with some embodiments. Electronic user devices 130a,b,c can each be associated with a particular brick-and-mortar retail entity and have no affiliation with each other (i.e. the brick-and-mortar retail entities are unaffiliated). For example, inventory transactions can include information reflective of inventory item sales, volume, shipping, and/or packing. Electronic user devices 130a,b,c can each include one or more point of sale systems 134, which is software that completes retail transactions, in accordance with some embodiments. For example, point of sale system 134 can be configured to transmit retail transaction related information, such as sales information, to inventory control system 132.

Electronic user devices 130a,b,c can each include one or more inventory control systems 132, which is software that manages and/or locates inventory items, in accordance with some embodiments. Inventory control system 132 can record inventory transaction events, for example, sales, delivery, shipping, and/or stocking. Inventory transaction events may be uploaded to inventory control system 132 using a barcode scanner and/or radio frequency reader. Inventory items tracked by inventory control system 132 can be attached to radio frequency-based tags. In some embodiments, point of sale system 134 and inventory control system 132 may be included in separate electronic user devices that communicate via network 140.

Electronic user device 110 can be configured to receive and store inventory information generated by a plurality of brick-and-mortar retail entities in a searchable manner, in accordance with some embodiments. Electronic user device 110 can include one or more control circuits 111 communicatively coupled to information repository 134 and shopping search engine program (“SSEP 112”). Information repository 134 is an information store that can include SSI 124a, data files 116, and inventory information 114. In some embodiments, SSI 124a can be configured as downloadable software that may provide a GUI that can allows users to interface with shopping search engine SSEP 112.

In some embodiments, SSI 124a can be configured to be a desktop application or a web-based application that is platform independent (i.e., software that is accessible via the cloud). In some embodiments, inventory information 114 can include inventory transaction data points generated by each of the one or more inventory control systems 132. For example, inventory transaction data points can each include information corresponding to one or more descriptive characteristics of inventory items managed by the inventory control systems 132. For example, inventory information 114 can be configured to receive inventory transaction data point within a threshold time period of being generated (e.g., within several millisecond or a period of time where significant delay cannot be perceived by a human) by brick-and-mortar retail entity

By one approach, descriptive characteristics can correspond to inventory itemID (e.g., “ABC Organic Whole Milk), an inventory item type (e.g., perishable, non-perishable, apparel item, chemical, etc.), sourcing information (e.g., organic, reclaimed, biodegradable, fair trade, etc.), a merchantID (e.g., ABC Corp.), a merchant location (i.e., address), a price, and an in-store item location (e.g., aisle 3, etc.)

In some embodiments, data files 116 can include one or more of a userID, user location, inventory item search history, user purchase history (e.g., one or more inventory itemIDs, purchasing dates, manufacturerIDs, inventory item types, user age, gender, date of birth, similar user-related information, or a combination of two or more thereof). Data files 116 can include information that may be used to retail analytics, for example, by SSEP 112. SSEP 112 is software configured to function as a shopping search engine that queries brick-and-mortar inventory item data, in accordance with some embodiments.

The one or more control circuits 111 can be configured to perform one or more functions, steps, procedures disclosed herein. For example, the control circuits 111 can be configured to perform one or more of the functions, steps, and/or procedures of SSEP 112. In some embodiments, the control circuits 111 can function in a similar manner to processor(s) 520 SSEP 112 can be configured to utilize inventory transaction data points received from one or more of the inventory control systems 132 to service requests generated by SIA 124b.

In some embodiments, SSEP 112 can be configured to identify one or more patterns included in the information repository 134 (e.g., classify inventory information 114 and/or data files 116 into object based on descriptive characteristics). In some embodiments, users of electronic user device 120 download copies of SSI 124b from electronic user device 110. By one approach, SSEP 112 can associate a particular copy of SSI 124b with a particular user. SSEP 112 can service text-, voice-, gesture-, image-, RFID-, and/or barcode-based requests.

In some embodiments, SSEP 112 can be configured to confirm whether one or more inventory transaction data points of inventory information 114 include one or more inventory items that share a threshold number of descriptive characteristics with one or more of the inventory items disclosed in a received request. For example, the threshold number can be user defined or may reflect a number that corresponds to at least a 51%, 75%, 85%, 95%, or similar probability that an inventory item of the inventory information 114 shares a statistically significant relationship with the inventory item disclosed in the received request. The aforementioned “statistically significant” standard can be selected and/or adjusted to suit the needs of a given application setting. The scale or units by which this measurement can be assessed can be any known, relevant scale/unit including, but not limited to, scales such as standard deviations, cumulative percentages, percentile equivalents, Z-scores, T-scores, standard nines, and percentages in standard nines.

Similarly, the threshold by which the level of statistical significance is measured/assessed can be set and selected as desired. By one approach the threshold is static such that the same threshold is employed regardless of the circumstances. By another approach the threshold is dynamic and can vary with such things as the relative size of the descriptive characteristics of the inventory item included in the request. Information included in information repository 134 can stored in one or more linked lists, arrays, search trees, hash tables, similar storage method, or a combination of two or more thereof and may be searched using a linear search, binary search, comparison search, brute-force search, similar searching methodologies, or a combination of two or more thereof.

In some embodiments, SSEP 112 can be configured to generate one or more notifications when the threshold number of descriptive characteristics are confirmed. For example, each notification can include information corresponding to one or more of the itemIDs, the merchantIDs, the merchant locations, the prices, the in-store-item locations, similar information, or a combination of two or more thereof.

In some embodiments, SSEP 112 can be configured to use the location-based information received from the electronic user device 120 and determine one or more travel routes from the received location to one or more of the merchant locations of inventory items identified in the processed request. In some embodiments, SSEP 112 can be configured to receive marketing information related to the inventory items managed by the one or more inventory control systems 132. For example, received marketing information can be stored in inventory 114. In some embodiments, received marketing information can be formatted for display via the search interface (e.g., using one or more predetermined font styles, font sizes, backgrounds, identifying marks, similar aesthetic elements, or a combination of two or more thereof).

In some embodiments, requests may also include a threshold search distance relative to a particular location (e.g., location of the electronic user device 120 or a user-defined location/distance) within which to search for brick-and-mortar retail entities associated with electronic user devices 130 having the one or more inventory items disclosed in the request. In some embodiments, SSEP 112 can be configured to confirm that the location of the brick-and-mortar retail entity is positioned within the threshold search distance.

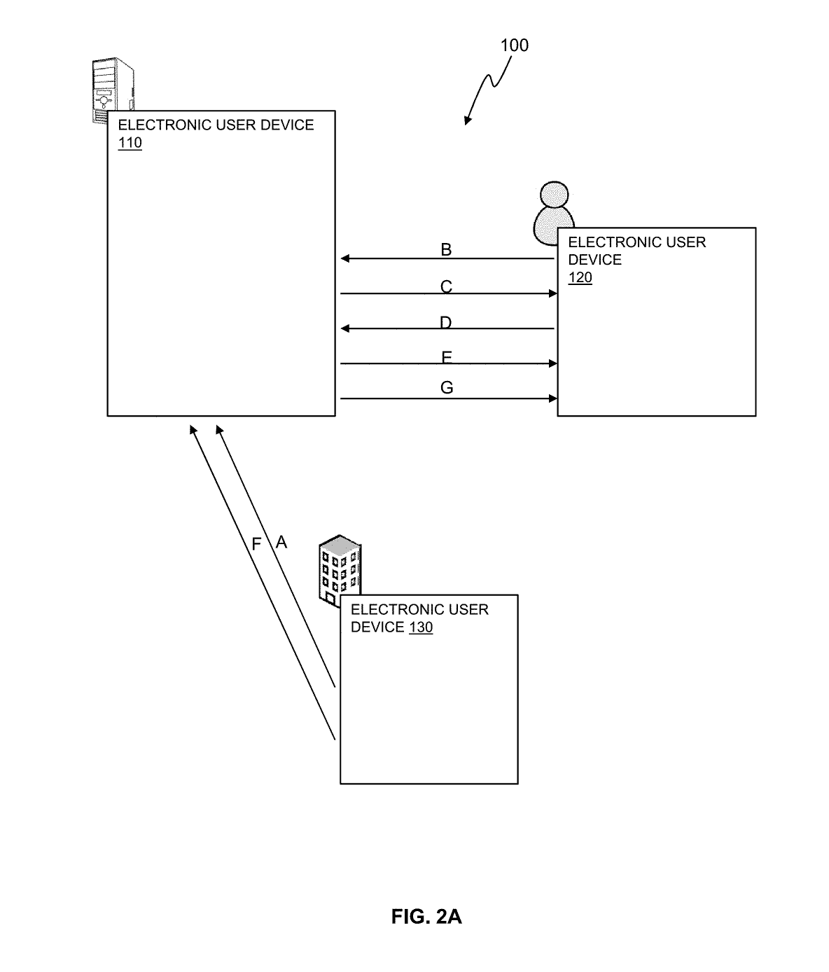

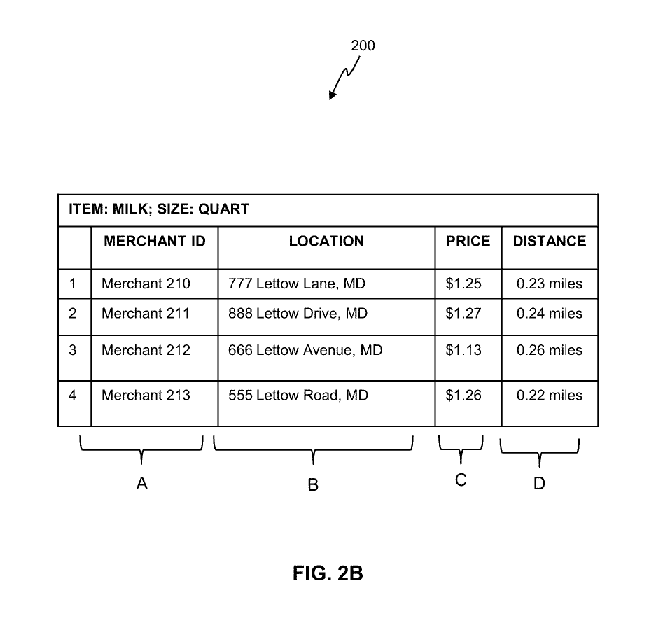

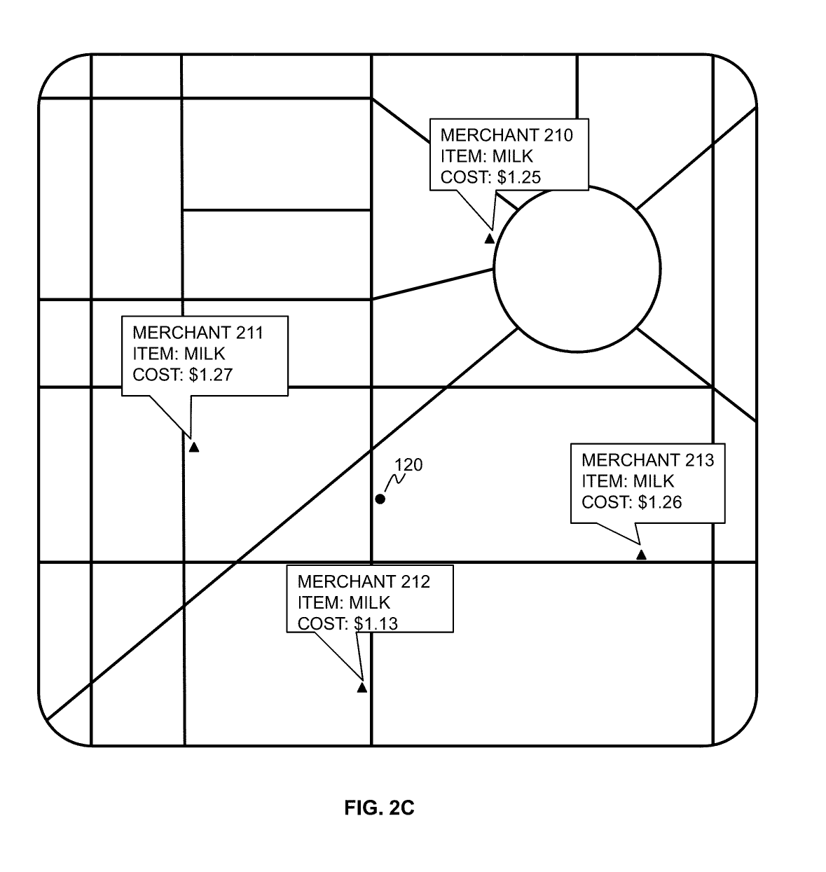

FIG. 2A depicts an information transaction scheme, in association with some embodiments. Specifically, FIG. 2A illustrates information transmissions that involve electronic user devices 110, 120, and 130a,b,c. For example, Merchant ABC desires to synchronize its inventory information to the central inventory listing included in inventory information 114, and uses transmission A to transmit inventory data to electronic user device 110. Subsequently, merchant ABC informs its customers that there is a related software application, i.e. SSI 124a, that customers can download and use to search for and/or purchase inventory items that are located in its inventory. Merchant ABC also transmits sales info to inventory information 114 via transmission A.

An interested customer transmits a request for SSI 124a to electronic user device 110 using transmission B. Electronic user device 110 utilizes transmission C to transmit a copy of SSI 124a to electronic user device 120. Upon receipt, electronic user device 120 saves the transmitted copy as SSI 124b. In response to a desire to locate a particular inventory item, for example, a quart of milk, for purchase, the user transmits, via transmission D, the related request to electronic user device 110. For example, SSI 124b allows users to determine the price limits for inventory items, which allows for tailoring of the inventory item search. SSI 124b allows users to search inventory information 114 via SSEP 112 via, for example, text input, voice input, gesture input, images of desired inventory items, and/or barcode scan input.

SSEP 112 services the request using the appropriate information included in inventory information 114 and data files 116 and transmits the serviced request to electronic user device 120 via transmission E. Transmission E can include inventory items that match the user's price limits. Transmission E can be an email, voice message, and/or a text message. The user can utilize the information included in the serviced request to make a purchase decision, which can entail the customer purchasing items using SSI 124b, for example, for in-store pick up or home delivery. Merchant ABC can inform users, for example, the user of electronic user device 120, of available sales information using transmission F. Electronic user device 110 receives transmission F and transmits the sales information to electronic user device 120, via transmission G. Electronic user device 110, via SSEP 112, can restrict the transmission of the sale information to those users that have signed up to receive information related to Merchant ABC. Electronic user device 110, via SSEP 112, can transmit the sales information to all copies of SSI 124b.

FIG. 2B is discussed in relation to FIG. 2C. FIG. 2B depicts a serviced search request (“SSR”), generally 200, in accordance with some embodiments. SSEP 112 serviced SSR 200, which is related to a search for a quart of milk. SSR 200 comprises data columns (“columns”) A, B, C, and D, which depicts merchantID, location, price (regular or sale), and distance, respectively. Although not shown, SSR 200 may also comprise product images, product attributes, in-store location, and/or directions to the associated merchants. FIG. 2C depicts a graphical illustration of SSR 200, in accordance with some embodiments. The graphical representation of SSR 200 illustrates a type of search result illustration that can be transmitted to customers. FIG. 2C illustrates the general position of merchants 210, 211, 212, and 213 relative to electronic user device 120. The relative position of electronic user device 120 can be determined utilizing global positioning information or can be user defined. FIG. 2C may depict a graphical output that is transmitted via transmission E.

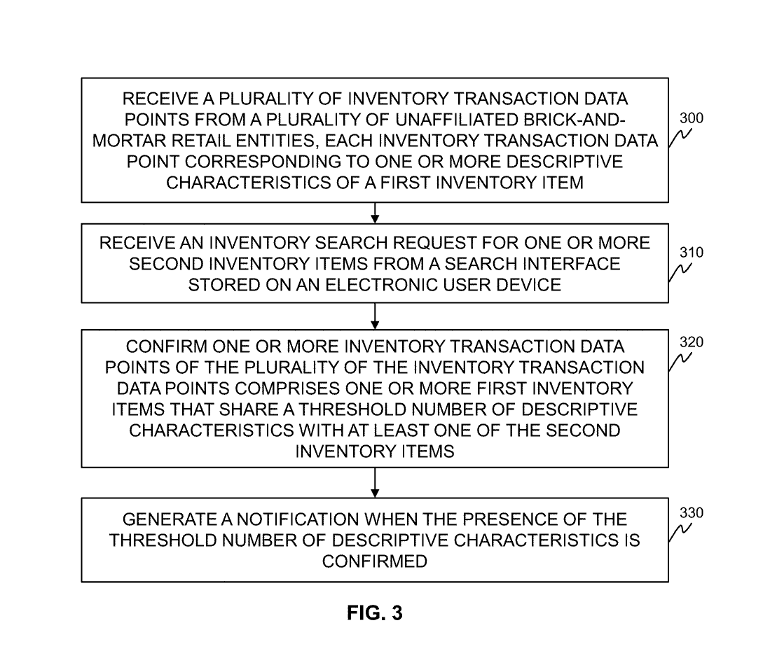

FIG. 3 illustrates the operational steps of a process, in accordance with some embodiments. A plurality of inventory transaction data points can be received from a plurality of unaffiliated brick-and-mortar retail entities at step 300. For example, each inventory transaction data point can include information corresponding to the descriptive characteristics of one or more first inventory items, where each descriptive characteristic comprising information corresponding to one or more of an itemID, an item type, sourcing information, a merchantID, a merchant location, a price, and an in-store item location. At step 310, receiving, via a control circuit, One or more inventory search requests for one or more second inventory items can be received from one or more search interfaces each stored on an electronic user device. At step 320, one or more inventory transaction data point of a plurality of the inventory transaction data points can be confirmed to correspond to one or more first inventory items that each share a threshold number of descriptive characteristics with at least one of the second inventory items. At step 330, one or more notifications can be generated when the presence of the threshold number of descriptive characteristics is confirmed, where each notification can include information corresponding to one or more of the threshold number of descriptive characteristics of the first inventory item.

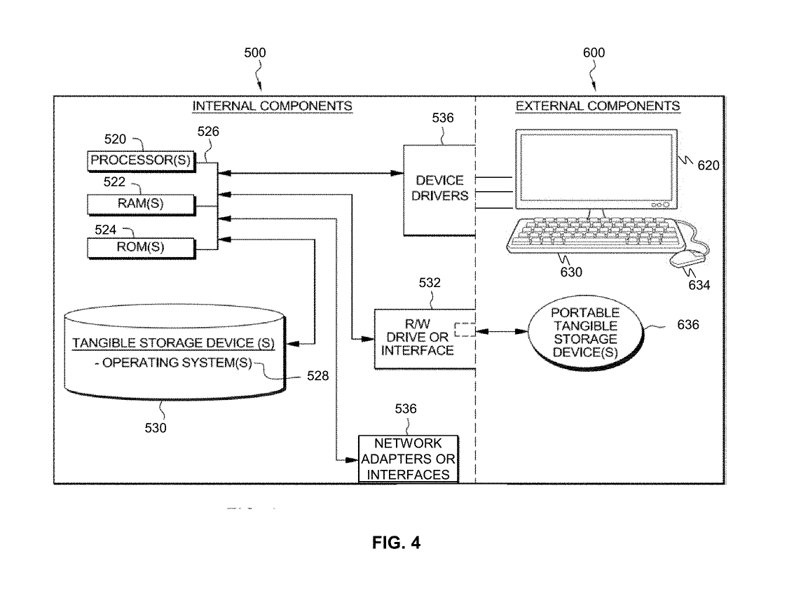

FIG. 4 depicts a block diagram of components of electronic user devices 110, 120, and/or 130, in accordance with some embodiments. Data processing system 500, 600 is representative of any electronic device capable of executing machine-readable program instructions. Data processing system 500, 600 may be representative of a smart phone, a computer system, PDA, or other electronic devices. Examples of computing systems, environments, and/or configurations that may represented by data processing system 500, 600 include, but are not limited to, personal computer systems, server computer systems, thin clients, thick clients, wearable computer, hand-held or laptop electronic user devices, multiprocessor systems, microprocessor-based systems, network PCs, minicomputer systems, and distributed cloud computing environments that include any of the above systems or devices.

Electronic user devices 110, 120, and/or 130 can includes internal components 500 and external components 600 as illustrated in FIG. 4. Internal components 500 includes one or more processors 520, one or more computer-readable RAMs 522 and one or more computer-readable ROMs 524 on one or more buses 526, and one or more operating systems 528 and one or more computer-readable tangible storage devices 530. One or more of SSEP 112 and information repository 113 are stored on one or more of the respective computer-readable tangible storage devices 530 for execution by one or more of processors 520 via one or more of the respective RAMs 522 (which typically include cache memory). In the embodiment illustrated in FIG. 4, computer-readable tangible storage device 530 is a magnetic disk storage device of an internal hard drive. Alternatively, computer-readable tangible storage device 530 is a semiconductor storage device, such as ROM 524, EPROM, flash memory or any other computer-readable tangible storage device that can store a computer program and digital information.

Internal components 500 also include a R/W drive or interface 532 to read from and write to one or more portable computer-readable tangible storage devices 636, such as a CD-ROM, DVD, memory stick, magnetic tape, magnetic disk, optical disk or semiconductor storage device. SSEP 112 and information repository 134 can be stored on one or more of the respective portable computer-readable tangible storage devices 636, read via the respective R/W drive or interface 532 and loaded into the respective computer-readable tangible storage devices 530.

Internal components 500 also includes network adapters or interfaces 536 such as a TCP/IP adapter cards, wireless Wi-Fi interface cards, or 3G or 4G wireless interface cards or other wired or wireless communication links. SSEP 112 and information repository 134 can be downloaded to electronic user device 110, respectively, from an external computer via a network (for example, the Internet, a local area network or other, wide area network) and respective network adapters or interfaces 536. From the network adapters or interfaces 536, SSEP 112 and information repository 113 in electronic user devices 110 are loaded into the respective computer-readable tangible storage devices 530. The network may comprise copper wires, optical fibers, wireless transmission, routers, firewalls, switches, gateway computers and/or edge servers.

External components 600 can include a computer display monitor 620, a keyboard 630, and a computer mouse 634. External components 600 can also include touch screens, virtual keyboards, touch pads, pointing devices gesture-based input devices, and other human interface devices. Internal components 500 also include device drivers 540 to interface to computer display monitor 620, keyboard 630 and computer mouse 634. The device drivers 540, R/W drive or interface 532 and network adapters or interfaces 536 comprise hardware and software (stored in storage device 530 and/or ROM 524).

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, though the Internet using an Internet Service Provider).

In some embodiments, systems are provided to enable a consumer to search the inventory of an enable a consumer to search the inventory of a plurality of unaffiliated brick-and-mortar retail entities to facilitate purchase opportunities. The system may include one or more electronic user devices each comprising a search interface stored thereon. One or more databases of information can be communicatively coupled to a plurality of unaffiliated brick-and-mortar retail entities and configured to store a plurality of inventory transaction data points received from the plurality of unaffiliated brick-and-mortar retail entities. By one approach, each inventory transaction data point can correspond to one or more descriptive characteristics of a first inventory item, where each descriptive characteristic can correspond to information comprising at least one of an itemID, an item type, sourcing information, a merchantID, a merchant location, a price, and an in-store item location.

One or more control circuits can be communicatively coupled to a transceiver and the databases. The control circuits can be configured to receive one or more inventory search requests for one or more second inventory items from the one or more search interfaces. The control circuits can also be configured to confirm that one or more inventory transaction data points of the plurality of inventory transaction data points comprises one or more first inventory item that each share a threshold number of descriptive characteristics with at least one of the second inventory items. The control circuits can also be configured to generate one or more notifications when the threshold number of descriptive characteristics are confirmed, the notification comprising information corresponding to one or more of the threshold number of descriptive characteristics.

In some embodiments, methods are provided to enable a consumer to search the inventory of a plurality of unaffiliated brick-and-mortar retail entities to facilitate purchase opportunities. Some of these methods can receive a plurality of inventory transaction data points from a plurality of unaffiliated brick-and-mortar retail entities, where each inventory transaction data point can comprise information corresponding to one or more descriptive characteristics of a first inventory item. By one approach, each descriptive characteristic can include information corresponding to one or more of an itemID, an item type, sourcing information, a merchantID, a merchant location, a price, and an in-store item location.

One or more inventory search requests can be received from one or more search interfaces, where each request can include information corresponding to one or more second inventory items. For example, each of the search interfaces can be stored on an electronic user device. One or more inventory transaction data points of a plurality of the inventory transaction data points can each be confirmed to include a first inventory item that shares a threshold number of descriptive characteristics with at least one of the second inventory items. One or more notifications can be generated when the presence of the threshold number of descriptive characteristics is confirmed. For example, the one or more notifications can include information corresponding to one or more of the threshold number of descriptive characteristics of the first inventory item.

Based on the foregoing, computer system, method and program product have been disclosed in accordance with the present invention. However, numerous modifications and substitutions can be made without deviating from the scope of the present invention. Therefore, the present invention has been disclosed by way of example and not limitation.

What is claimed is:

1. A method comprising:
receiving, via a first computing device, a plurality of inventory transaction data points and storing the plurality of inventory transaction data points in an information store;
servicing, via the first computing device, an inventory item search request received from a second computing device;
wherein an inventory transaction data point included in the plurality of inventory transaction data points is associated with a first inventory item, a merchantID, a merchant location, a price, and/or an in-store location;
wherein the inventory item search request is associated with a second inventory item; and
wherein the step of servicing the inventory item search request includes determining whether the second inventory item matches the first inventory item and, in response to determining that the second inventory item matches the first inventory item, determining the merchantID, the merchant location, the price, and/or the in-store location associated with the first inventory item.

2. The method of claim 1, further comprising determining the distance of the location of the merchant relative to the second computing device.

3. The method of claim 1, wherein the inventory item search request comprises text, a voice command, a barcode scan, and/or an image capture.

4. The method of claim 1, further comprising transmitting, via the first computing device, sales information associated with the inventory item to the second computing device.

5. The method of claim 1, further comprising determining, via the first computing device, a distance between the second computing device and the merchant location and/or directions from the second computing device to the merchant location.

6. The method of claim 1, wherein the inventory transaction data point included in the plurality of inventory transaction data points is received, via the first computing device, in real-time or periodically at a pre-determined time period.

7. A computer program product, the computer program product comprising a computer readable storage medium having program code embodied therewith, the program code executable by one or more processors to:
receive, via the one or more processors, a plurality of inventory transaction data points and store the plurality of inventory transaction data points in an information store;
service, via the one or more processors, an inventory item search request received from a second set of one or more processors;
wherein an inventory transaction data point included in the plurality of inventory transaction data points is associated with a first inventory item, a merchantID, a merchant location, a price, and/or an in-store location;
wherein the inventory item search request is associated with a second inventory item; and
wherein the program code to service the inventory item search request includes program code to determine whether the second inventory item matches the first inventory item and, in response to determining that the second inventory item matches the first inventory item, determine the merchantID, the merchant location, the price, and/or the associated in-store location associated with the first inventory item.

8. The method of claim 7, further comprising program code to determine the merchant location relative to the second set of one or more processors.

9. The method of claim 7, wherein the inventory item search request comprises text, a voice command, a barcode scan, and/or an image capture.

10. The method of claim 7, further comprising program code to transmit, via the one or more processors, sales information associated with the inventory item to the second computing device.

11. The method of claim 7, further comprising determining, via the first computing device, a distance between the second computing device and the merchant location and/or directions from the second computing device to the merchant location.

12. The method of claim 7, wherein the inventory transaction data point included in the plurality of inventory transaction data points is received, via the first computing device, in real-time or periodically at a pre-determined time period.

13. A computer system:
one or more computer processors;
one or more computer-readable storage media;
program instructions stored on the computer-readable storage media for execution by at least one of the one or more processors, the program instructions comprising:
program instructions to
receive, via the one or more computer processors, a plurality of inventory transaction data point and store the plurality of inventory transaction data point in an information store information store;
service, via the one or more computer processors, an inventory item search request received from a second set of one or more computer processors;
wherein the inventory transaction data point included in the plurality of inventory transaction data points is associated with a first inventory item, an merchantID, a merchant location, a price, and/or an in-store location;
wherein the inventory item search request is associated with a second inventory item; and
wherein the program code to service the inventory item search request includes program instructions to determine whether the second inventory item matches the first inventory item and, in response to determining that the second inventory item matches the first inventory item, determine the merchantID, the merchant location, the price, and/or the associated in-store location associated with the first inventory item.

14. The computer system of claim 13, further comprising program instructions to determine the merchant location relative to the second set of one or more computer processors.

15. The computer system of claim 13, wherein the inventory item search request comprises text, a voice command, a barcode scan, and/or an image capture.

16. The computer system of claim 13, further comprising program instructions to transmit, via the one or more computer processors, sales information associated with the inventory item to the second computing device.

17. The computer system of claim 13, further comprising program instructions to determine, via the first computing device, a distance between the second computing device and the merchant location and/or directions from the second computing device to the merchant location.

18. The computer system of claim 13, wherein the inventory transaction data point included in the plurality of inventory transaction data points is received, via the first computing device, in real-time or periodically at a pre-determined time period.
